(19) United States
(12) Patent Application Publication
(10) Pub. No.: US 2026/0211753 A1
(43) Pub. Date: Jul. 23, 2026

(54) Inferred User Analytics

(71) Applicant: iBiquity Digital Corporation, Columbia, MD (US)

(72) Inventors: Robert M. Dillon, Mendham, NJ (US); Paul R. Venezia, Keene, NH (US)

(73) Assignee: iBiquity Digital Corporation, Columbia, MD (US)

(21) Appl. No.: 19/139,582

(22) PCT Filed: Mar. 8, 2023
(86) PCT No.: PCT/US2023/014832

§ 371 Date: Jun. 16, 2025

Related U.S. Application Data
(60) Provisional application No. 63/387,841, filed on Dec. 16, 2022.

(51) Int. Cl. G06F 9/54; G06N 5/04

(52) U.S. Cl. CPC G06F 9/542; G06N 5/04

(57) ABSTRACT

User behavior metrics may be inferred from user interactions with a client application through application programming interfaces (APIs) that perform backend services User behavior metrics may be inferred from user behavior that is correlated with data streams derived from traffic created by user interactions. Such user behavior metrics may be used to adjust client application offerings to increase the utility of the client application and function independently as a product to third parties.

### CROSS REFERENCE TO RELATED APPLICATIONS

This application claims the benefit of the filing date of U.S. Provisional Patent Application No. 63/387,841 filed Dec. 16, 2022, the disclosure of which is hereby incorporated herein by reference.

### BACKGROUND

User metrics are an important part of many digital products. The ability to learn information about users' preferences and behaviors is important both in terms of delivering digital services as well as being a product unto itself. Traditionally user metrics are gathered explicitly by tracking and recording user actions as the user interacts with the application. However, in some cases, direct measurement is not possible due to privacy preferences and other restrictions. This restricts the application provider from gaining important insights to aid in improving the user's experience.

### SUMMARY

The present disclosure provides for inferring user behavior metrics without any user identifying information. This is accomplished by selecting data streams created from user interaction with a client application and correlating said data streams to user behavior in order to infer user behavior metrics. The user behavior metrics may be used to adjust client application offerings.

One aspect of the disclosure provides a method of inferring user behavior using a client application, the method comprising identifying, with one or more processors, application programming interface (API) traffic on a client application for a digital service, the API traffic generated by a user's interactions with the client application, correlating, with the one or more processors, the API traffic with particular user behaviors, and inferring, with the one or more processors, user behavior metrics based on the API traffic.

The client application may comprise a collection of endpoints, each of which deliver a specific subset of services of the digital service. The endpoints may correlate with one or more of a plurality of features of the client application. Such features may include, for example, available selections, actions, inputs, and outputs delivered by the client application to the user.

According to some examples, the method may further include adjusting offerings of the digital service based on the user behavior metrics. For example, the digital service may be a media broadcasting service, and adjusting the offerings may comprise changing specific media assets that are broadcast, changing a frequency of broadcasting particular media assets, or changing a timing of broadcasting particular media assets. The media assets may be songs and the media broadcasting service may be a radio broadcasting service.

In some examples, the user behavior metrics may categorize user behaviors based on one or more parameters selected from the group consisting of: time, location, frequency, popularity, and number of clients using one of a plurality of features.

Inferring the user behavior metrics may be performed in real time while the user is interacting with the client application. A “disp” parameter may be used to determine if live requests were used for a “tuned” station, a “guide”, or a “preset” to permit more granular inference of behavior. The disp parameter is used to describe the status of a data set to a system and instruct the system what to do with the data set after termination of a step or job.

Another aspect of the disclosure provides a system comprising memory and one or more processors in communication with the memory. The one or more processors may be configured to identify API traffic on a client application for a digital service, the API traffic generated by a user's interactions with the client application, correlate the API traffic with particular user behaviors, and infer user behavior metrics based on the API traffic.

According to some examples, the client application may include a collection of endpoints, each of which deliver a specific subset of services of the digital service.

The one or more processors may be further configured to adjust offerings of the digital service based on the user behavior metrics.

The user behavior metrics may categorize user behaviors based on one or more parameters selected from the group consisting of: time, location, frequency, popularity, and number of clients using one of a plurality of features.

Inferring the user behavior metrics may be performed in real time while the user is interacting with the client application.

The user behavior may be inferred without any identifying information of the user.

Yet another aspect of the disclosure provides a non-transitory computer-readable medium storing instructions executable by one or more processors for performing a method for inferring user behavior using a client application. Such method may include identifying API traffic on a client application for a digital service, the API traffic generated by a user's interactions with the client application, correlating the API traffic with particular user behaviors, and inferring user behavior metrics on the API traffic. The user behavior metrics may categorize user behaviors based on one or more parameters selected from the group consisting of: time, location, frequency, popularity, and number of clients using one of a plurality of features.

### DESCRIPTION OF DRAWINGS

FIG. 1 illustrates an application program interface (API) and example endpoints related to potential features of a client application, according to aspects of the disclosure.

FIG. 2 depicts an example of correlating data streams from API traffic, a client's interaction on a user device, and the selection of data streams related to the client's interaction, according to aspects of the disclosure.

FIG. 3A depicts an example of how the user behavior metrics may be used to adjust offerings by determining song selection, according to aspects of the disclosure.

FIG. 3B depicts an example of how the user behavior metrics may be used by advertisers to set advertising prices, according to aspects of the disclosure.

FIG. 4 is a block diagram illustrating an example method according to aspects of the disclosure.

FIG. 5 depicts an example system, according to aspects of the disclosure.

### DETAILED DESCRIPTION

The present disclosure relates generally to a system and method of inferring user behavior using a client application without requiring user identifying information.

Client applications have backend services that are accessed by the user through Application Programming Interfaces (API). The API is a set of definitions and protocols that allow different applications to interact. The API may include a collection of endpoints. Each endpoint may be a digital location from which the API can access resources needed to carry out a function. For example, each API endpoint may generally correlate with one or more features or services that the client application offers. A feature may be options or attributes provided by the client application as output to a user for potential interaction by the user. For example, features may include available selections, actions, inputs, and outputs delivered by the client application to the user. For example, a broadcast radio API may contain endpoints that deliver a list of all stations that are receivable at a location, information on a particular radio station, or content information about what is currently playing on a radio station (such as song, artist, station frequency, or radio show).

As the user interacts with features or services of the client application, the endpoints are activated creating traffic on the API's backend services. The traffic on the API creates data streams that may be analyzed to infer user behavior.

User behavior metrics are inferred by first identifying which data streams are the result of user interaction with the client application. The identified data streams may be correlated with the user behavior in which user behavior relates to the user's decision making on the client application. For example, with a broadcast radio API user behavior may include tuning to a radio station, selecting a radio station from a guide, or changing the station when a particular song is played.

The user behavior may be used to infer user behavior metrics. User behavior metrics may categorize behaviors based on time, location, frequency, popularity, and number of clients using a particular feature or service. For example, with a broadcast radio API user behavior metrics may be the popularity of a particular station, popularity of a song or artist, attractiveness of a station in comparison to others, etc.

User behavior metrics are used to determine modifications to service offerings where offerings are the output of the client application features. An application provider may utilize the user behavior metrics to, for example, tune app behavior and increase its utility with users. For example, application providers may change the presentation and display of certain features to make the respective features more attractive to the user. In another example, for a broadcast radio API, an application provider may determine which songs are played based on popularity of the artist or popular listening times.

Interested parties may also utilize user behavior metrics for their own motivations. For example, an advertiser may be an interested party for a broadcast radio API in which the advertiser sets advertising prices according to popular listening times, popular radio shows, popular artists, etc.

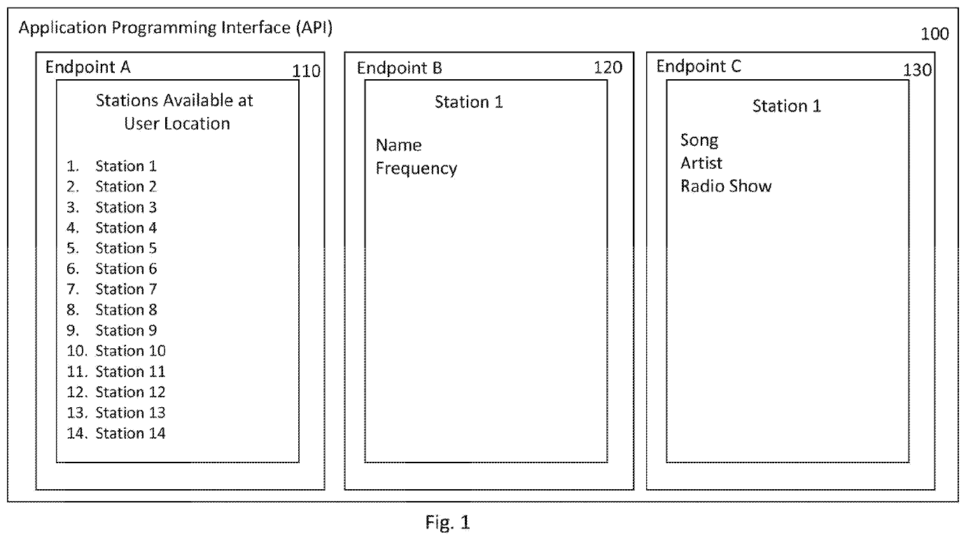

FIG. 1 illustrates an example of a radio broadcast API 100 made up of a plurality of endpoints 110,120, 130. In the example of FIG. 1, first endpoint A 110 delivers a list of stations available to the user at a location of the user. Second endpoint B 120 delivers the name and frequency of a station selected by the user for listening, such as station 1. Endpoint C 130 delivers information such as the song, artist, and radio show of station 1. Each of the three endpoints shown in FIG. 1 are related to a radio broadcast API, however the endpoints are not limited to this context. Additionally, although three endpoints are shown, in other embodiments an API may have fewer than three endpoints or more endpoints than those illustrated in FIG. 1.

An endpoint of an API is one end of a communication channel in which the APIs can access the data they need to carry out the functions of the API. An endpoint may be located on the server side of the API. Each endpoint may be located on the same server or on a plurality of servers. Although the endpoints in FIG. 1 are related to a radio broadcast API, an API may contain endpoints related to a plurality of different API functions. For example, the endpoints of an API may be directed to credit card payments, location services, photo sharing, hashtag identification, etc. Furthermore, a collection of endpoints may be directed to similar functions or they may be directed to different services of the API.

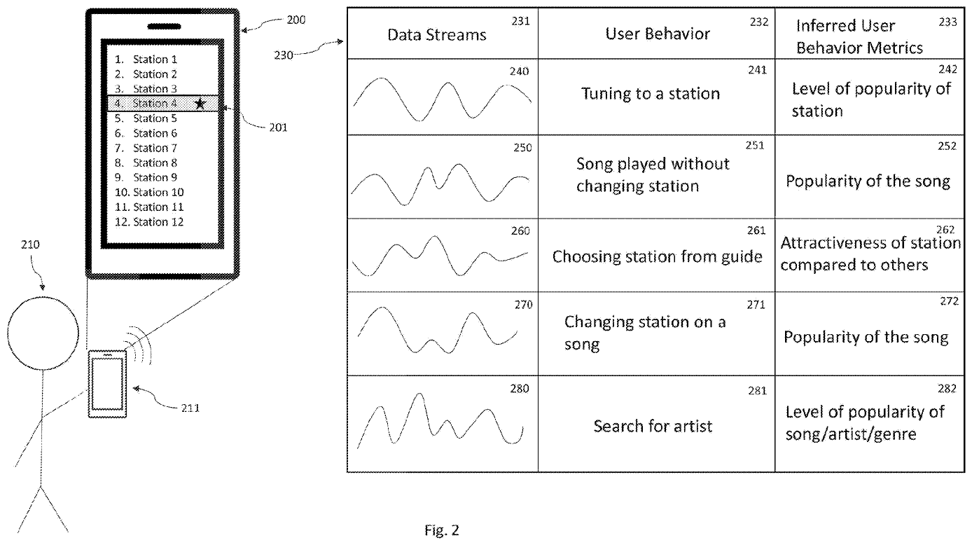

FIG. 2 illustrates an example of how user behavior metrics are inferred from identified data streams 231 based on the traffic produced from endpoint 1 110, depicted in FIG. 1. A feature, such as a listing of available radio stations, may be delivered from endpoint 110. For example, the user may be able to select a station, make it a preset station on their user device, or indicate that the station is the favorite station of the user. As the user interacts with the feature delivered by endpoint 1 110, traffic is created on the API producing data streams 231. Once the data streams 231 are identified as the result of user interaction, they may be correlated with user behavior 232. A plurality of user behavior metrics may be inferred from one user behavior correlated with a plurality of data streams. For example, the data stream 250 shown in FIG. 2 may also elicit inferred behavior metrics relating to the time of day spent listening to the radio and the length of time that the user listened to a station, etc.

The chart 230 depicted in FIG. 2 provides examples of how data streams 231 created by user interaction 211 may be correlated with user behavior 232 to infer user behavior metrics 233. A plurality of examples are depicted in the chart 230 but numerous alternative or additional examples are possible. In one example the data stream 240 is the result of the user choosing a radio station in which the correlated user behavior 241 is that the user tuned to said station. Based on this correlation the inferred user behavior metric 242 is that the station is popular with listeners to specifically be chosen amongst all radio stations available to the user 210.

In another example depicted in FIG. 2 the data stream 250 is the result of the user listening to the entirety of a song in which the correlated user behavior 251 is that the station was not changed while the song was playing. Based on this correlation the inferred user behavior metric 252 is to determine the popularity of the song.

In another example depicted in FIG. 2 the data stream 260 is based on the user interaction 211 with endpoint 1, depicted in FIG. 1. The user 210 makes a user selection 201 of radio stations on the user device 200 from a list of stations therefore interacting with the API endpoint that provides a list of available stations at a particular location. This interaction creates a data stream 260 in which the correlated user behavior 261 is the choosing of a station displayed alongside a plurality of other stations. Based on this correlation the inferred user behavior metric 262 is the attractiveness of a particular radio stations in comparison to adjacently displayed radio stations.

In another example depicted in FIG. 2 the data stream 270 is the result of the user tuning away from a station in which the correlated user behavior 271 is that the station was changed due to the song that was playing. Based on this correlation the inferred user behavior metric 272 is the popularity of the song.

In another example depicted in FIG. 2 the data stream 280 is the result of the user inputting a value into a search function in which the correlated user behavior 281 is the user was searching for a particular artist 281. Based on this correlation the inferred user behavior metric 282 is the popularity of the artist/song/genre that was searched for.

Data streams may be stored in a log and correlated with user behavior for as long as the data streams are stored. In one embodiment the inferred behavior metrics may be derived in real time as the user uses the client application. In some embodiments, when the inferred behavior metrics are derived in real time a disposition, or “disp”, parameter is required to determine the user's interactions and to permit a more granular inference of behavior without explicit reports. A “disp” parameter is a coding function used to describe the status of a data set to a system in order to tell the system what to do. Use of the a “disp” parameter, for example, allows for the determination whether live requests were used for a “tuned” station, a “guide”, or a “preset” permitting for a more granular inference of behavior in real time.

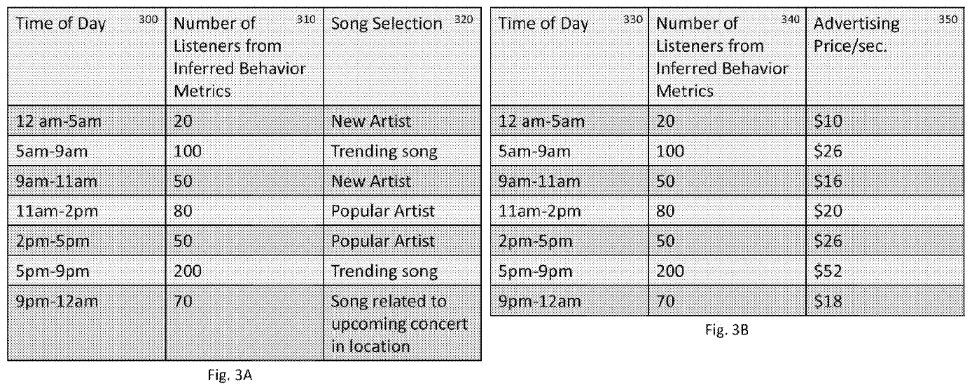

FIGS. 3A-3B, illustrate examples of how the inferred user behavior metrics may be utilized to adjust offerings by application providers and interested parties. Offerings may be considered as the deliverable content by application providers and interested parties to the API. For example, an offering by an application provider may be the selection of songs to be played consecutively on a station. FIG. 3A describes how an application provider may use the inferred behavior metrics to determine what songs will be played at different times of the day based on the inferred number of listeners. FIG. 3B describes how an interested party, such as an advertiser, may use the same inferred behavior metrics as those in FIG. 3A to determine advertising prices per second.

The chart in FIG. 3A is an example of how inferred behavior metrics may be used by an application provider in determining what content to deliver to users. The chart depicts an example related to a radio broadcast API showing the relationship between the time of day 300 and the number of listeners, which was determined from the inferred behavior metrics 310, in order to determine a song selection 320 for corresponding times of day. For example, at a time when most users are using the radio broadcast API the application provider may choose a recently trending song that they believe most people will enjoy. Although this example is related to a radio broadcast API and shows an example of how an application provider may use the inferred user behavior metrics, similar analyses may be used for a plurality of other types of APIs and similar metrics may be used by application providers in a plurality of other determinations beyond song selection.

The chart in FIG. 3B is an example of how an interested party, such as an advertiser, may use the inferred user behavior metrics to set advertising prices. The chart shows the relationship between the time of day 330 and the number of listeners, which was determined based on the inferred user behavior metrics 340, in order to determine a set of advertising prices per second 350 based on those metrics. For example, at a time when most users are using the radio broadcast API the advertising price per second is the highest. Although this example is related to a radio broadcast API and shows an example of how an advertiser may use the inferred user behavior metrics, similar analyses may be used for a plurality of other types of APIs and interested parties. Additionally similar metrics may also be used by advertisers to make a plurality of other determinations beyond advertising prices.

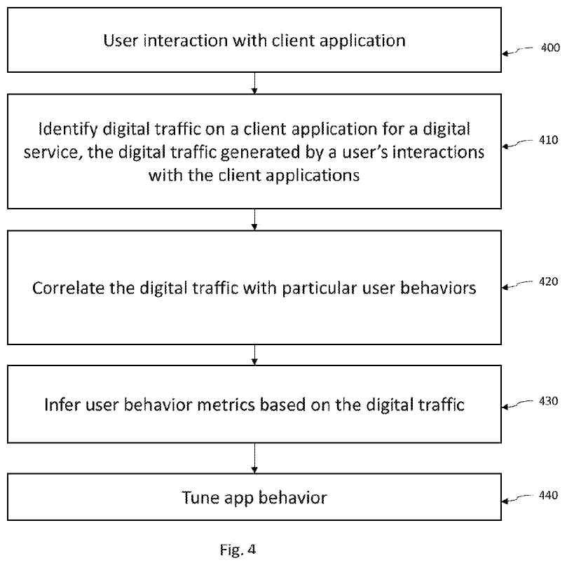

FIG. 4 illustrates an example method for inferring user behavior. The method may be performed by, for example, a computing device or module, or a system of one or more distributed server processes. While the operations are described in a particular order, it should be understood that the order may be modified. Moreover, operations may be performed simultaneously, and operations may be added or omitted.

In block 400, the user interacts with the client application, such as by selecting a feature of the client application to engage with. In block 410, the client application provides the user with one or more features with which the user may interact. Examples of user interactions for a radio broadcast API may include, but are not limited to, selecting a radio station, adjusting a volume, marking a song as “liked” or “loved” or “favorite” or “do not play again” etc., accessing a link to download the song, etc. The client application may be any of a variety of different types of client applications and is not limited to the radio broadcast API that is used as an example throughout this application. For example, the API may be a video streaming API, a social media API, a multi-way communication API, etc. Examples of other types of user interactions, such as for other types of client APIs, may include sharing a post with another profile, starting a video call, opening an application programming interface, etc.

In block 410, digital traffic is identified from backend services of the API. The digital traffic is created as the result of the user's interactions with the client application. For example, as the API receives queries and sends data back to the client, the client query and the data requested are logged, allowing other processes to analyze the interaction and infer actions.

In block 420, the identified digital traffic is correlated with user behaviors. For example, this may be done by matching the timestamps of the user interactions with another source of information relating to the song or program playing on the radio station that the user is listening to. Examples of correlated user behavior may be, but are not limited to, changing a radio station due to a dislike of the song that was playing, the number of times a day an application programming face is opened to interact with, the number of video calls taking place in a day, etc. A user behavior data set may be created from the identified digital traffic and the correlated user behavior related to said digital traffic.

In block 430, the user behavior metrics are inferred from the user behaviors. By analyzing the user behavior dataset with other relevant datasets from other sources, insights into user likes and dislikes can be determined with a reasonable degree of accuracy. The metrics may be inferred from aggregated digital streams created by numerous different users. In other examples, the metrics may be inferred from the interactions of an individual user.

In block 440, the inferred user behavior metrics are used to tune app behavior to improve the utility to the users, such as by helping to determine what songs are played at a specific time of day. For example, an application provider may use the inferred user behavior metrics to determine the time of day that elicits the most listeners, and in response to this information select songs that are most popular to play.

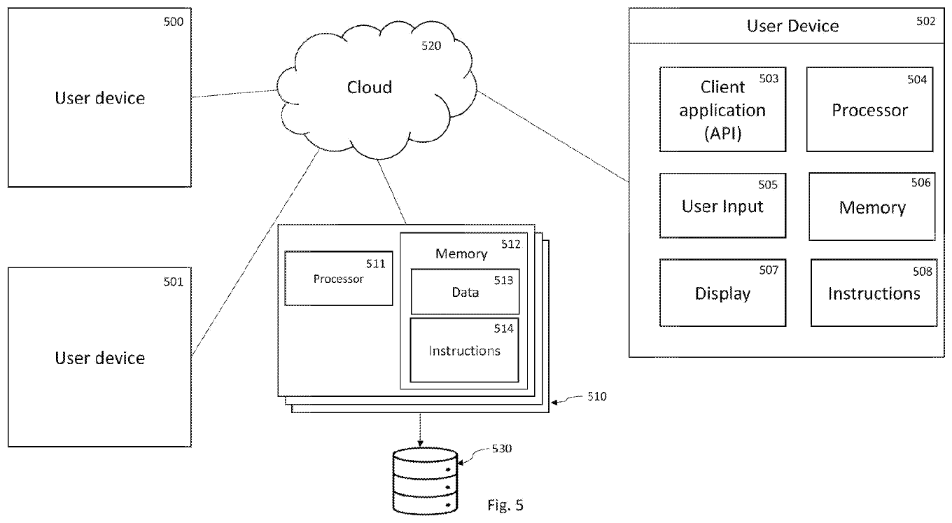

FIG. 5 illustrates an example system for implementing inferred user analytics. In particular, the system includes one or more client devices 500-502 in communication with one or more servers 510 through a network 520. For example, each of a number of different client devices 500-502 may interact with client applications 503 that receive content from the server 510. The server 510 may select what data streams are related to user interactions, and infer user behavior metrics from the selected data streams. While several client devices 500-502 are shown, it should be understood that any number of client devices 500-502 may communicate with the one or more servers 510 through the network 520.

The server 510 includes one or more processors 511. The processors 511 can be any conventional processors, such as commercially available CPUs. Alternatively, the processors 511 can be dedicated components such as an application specific integrated circuit (“ASIC”) or other hardware-based processor. Although not necessary, the server 510 may include specialized hardware components to perform specific computing processes.

The memory 512 can store information accessible by the processor including data 513 and instructions 514 that can be executed by the processor retrieved, manipulated, or stored by the processor.

The instructions 514 can be a set of instructions executed directly, such as machine code, or indirectly, such as scripts, by the processor. In this regard, the terms “instructions,” “steps” and “programs” can be used interchangeably herein. The instructions 514 can be stored in object code format for direct processing by the processor, or other types of computer language including scripts or collections of independent source code modules that are interpreted on demand or compiled in advance. Functions, methods, and routines of the instructions are explained in more detail in the foregoing examples and the example methods above.

The data 513 can be retrieved, stored or modified by the processor 511 in accordance with the instructions 514. The data 513 can also be formatted in a computer-readable format such as, but not limited to, binary values, ASCII or Unicode. Moreover, the data 513 can include information sufficient to identify relevant information, such as numbers, descriptive text, proprietary codes, pointers, references to data stores in other memories, including other network locations, or information that is used by a function to calculate relevant data.

Although FIG. 5 functionally illustrates the processor 511, memory 512, and other elements of the server 510 as being within the same block, the processor 511, computer, computing device, or memory 512 can comprise multiple processors, computers, computing devices, or memories that may or may not be stored within the same physical housing. For example, the memory 512 can be a hard drive or other storage media located in housings different from that of server. Accordingly, references to a processor, computer, computing device, or memory will be understood to include references to a collection of processors, computers, computing devices, or memories that may or may not operate in parallel. For example, the server 510 may include server computing devices operating as a load-balanced server farm, distributed system, etc. Yet further, although some functions described above are indicated as taking place on a single computing device having a single processor, various aspects of the subject matter described herein can be implemented by a plurality of computing devices, for example, communicating information over a network.

The memory 512 can store information accessible by the processor, including instructions that can be executed by the processor. Memory 512 can also include data that can retrieved, manipulated or stored by the processor. The memory 512 may be a type of non-transitory computer readable medium capable of storing information accessible by the processor, such as a hard-drive, solid state drive, tape drive, optical storage, memory card, ROM, RAM, DVD, CD-ROM, write-capable, and read-only memories. The processor 511 can be a well-known processor or other lesser-known types of processors. Alternatively, the processor 511 can be dedicated controller such as an ASIC.

The instructions 514 can be a set of instructions executed directly, such as machine code, or indirectly, such as scripts, by the processor. In this regard, the terms “instructions,” “steps” and “programs” can be used interchangeably herein. The instructions 514 can be stored in object code format for direct processing by the processor, or other types of computer language including scripts or collections of independent source code modules that are interpreted on demand or compiled in advance. The instructions 514 may be executed to identify data streams related to user interactions and infer user behavior metrics from such data streams, as described above. The instructions 514 may further be executed to change service offerings in response to the user behavior metrics.

The data 513 can be retrieved, stored or modified by the processor in accordance with the instructions. For instance, although the system and method are not limited by a particular data structure, the data can be stored in computer registers, in a relational database as a table having a plurality of different fields and records, or XML documents. The data can also be formatted in a computer-readable format such as, but not limited to, binary values, ASCII or Unicode. Moreover, the data can include information sufficient to identify relevant information, such as numbers, descriptive text, proprietary codes, pointers, references to data stores in other memories, including other network locations, or information that is used by a function to calculate relevant data.

The servers 510 may be further coupled to an external storage 530, such as a database. The external storage 530 may store content for delivery to the client devices. The external storage 530 may further store banners for rendering at the client devices along with content. Such banners may include advertisements or other information. While the external storage is shown as a single database, it should be understood that the physical structure of the external storage can include multiple storage devices, wherein such multiple devices may be in communication with each other such as in a distributed storage system.

Each client device 500-502 may be configured similarly to one another and to the servers 510 in that they include a processor 504 and memory 506 including data and instructions executable by the processor 504. The structure of the processor and memory may be similar to that of the processor and memory, respectively, described above. The client devices may be any type of personal computing devices, such as laptops, desktop computers, tablets, gaming consoles, phones, augmented reality or virtual reality headsets, smart watches, smart glasses, home assistant hubs, or any other computing device including an API that may be interacted with by the user. Each client device may further include one or more user input 505 devices. Such input devices may include touchscreens, touchpads, keypads, cameras, microphones, joysticks, or any other device adapted to capture input signals from a user. Each client device may further include on or more displays 507. Such displays may include an liquid crystal display (LCD), light-emitting diode (LED), thin-film transistor LCD, quantum dot display (QLED), or any other device adapted to present signals to the user.

Further to the example systems described above, example methods are also described above. Such methods may be performed using the systems described above, modifications thereof, or any of a variety of systems having different configurations. It should be understood, that the operations involved in the above methods need not be performed in the precise order described. Rather, various operations may be handled in a different order or simultaneously, and operations may be added or omitted.

Moreover, in certain embodiments, acts or events can be performed concurrently, such as through multi-threaded processing, interrupt processing, or multiple processors or processor cores or on other parallel architectures, rather than sequentially. In addition, different tasks or processes can be performed by different machines and computing systems that can function together.

The various illustrative logical blocks, modules, methods, and algorithm processes and sequences described in connection with the embodiments disclosed herein can be implemented as electronic hardware, computer software, or combinations of both. To clearly illustrate this interchangeability of hardware and software, various illustrative components, blocks, modules, and process actions have been described above generally in terms of their functionality. Whether such functionality is implemented as hardware or software depends upon the particular application and design constraints imposed on the overall system. The described functionality can be implemented in varying ways for each particular application, but such implementation decisions should not be interpreted as causing a departure from the scope of this document.

While some examples described above refer to inferring behavior metrics relating to a broadcast radio API, the techniques described above may similarly be applied for other types of APIs.

The various illustrative logical blocks and modules described in connection with the embodiments disclosed herein can be implemented or performed by a machine, such as a general purpose processor, a processing device, a computing device having one or more processing devices, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general-purpose processor and processing device can be a microprocessor, but in the alternative, the processor can be a controller, microcontroller, or state machine, combinations of the same, or the like. A processor can also be implemented as a combination of computing devices, such as a combination of a DSP and a microprocessor, a plurality of microprocessors, one or more microprocessors in conjunction with a DSP core, or any other such configuration.

Embodiments of the system and method described herein are operational within numerous types of general purpose or special purpose computing system environments or configurations. In general, a computing environment can include any type of computer system, including, but not limited to, a computer system based on one or more microprocessors, a mainframe computer, a digital signal processor, a portable computing device, a personal organizer, a device controller, a computational engine within an appliance, a mobile phone, a desktop computer, a mobile computer, a tablet computer, a smartphone, and appliances with an embedded computer, to name a few.

Such computing devices can typically be found in devices having at least some minimum computational capability, including, but not limited to, personal computers, server computers, hand-held computing devices, laptop or mobile computers, communications devices such as cell phones and PDA's, multiprocessor systems, microprocessor-based systems, set top boxes, programmable consumer electronics, network PCs, minicomputers, mainframe computers, audio or video media players, and so forth. In some embodiments the computing devices will include one or more processors. Each processor may be a specialized microprocessor, such as a digital signal processor (DSP), a very long instruction word (VLIW), or other micro-controller, or can be conventional central processing units (CPUs) having one or more processing cores, including specialized graphics processing unit (GPU)-based cores in a multi-core CPU.

The process actions or operations of a method, process, or algorithm described in connection with the embodiments disclosed herein can be embodied directly in hardware, in a software module executed by a processor, or in any combination of the two. The software module can be contained in computer-readable media that can be accessed by a computing device. The computer-readable media includes both volatile and nonvolatile media that is either removable, non-removable, or some combination thereof. The computer-readable media is used to store information such as computer-readable or computer-executable instructions, data structures, program modules, or other data. By way of example, and not limitation, computer readable media may comprise computer storage media and communication media.

Computer storage media includes, but is not limited to, computer or machine readable media or storage devices such as Bluray discs (BD), digital versatile discs (DVDs), compact discs (CDs), floppy disks, tape drives, hard drives, optical drives, solid state memory devices, RAM memory, ROM memory, EPROM memory, EEPROM memory, flash memory or other memory technology, magnetic cassettes, magnetic tapes, magnetic disk storage, or other magnetic storage devices, or any other device which can be used to store the desired information and which can be accessed by one or more computing devices.

A software module can reside in the RAM memory, flash memory, ROM memory, EPROM memory, EEPROM memory, registers, hard disk, a removable disk, a CD-ROM, or any other form of non-transitory computer-readable storage medium, media, or physical computer storage known in the art. An exemplary storage medium can be coupled to the processor such that the processor can read information from, and write information to, the storage medium. In the alternative, the storage medium can be integral to the processor. The processor and the storage medium can reside in an application specific integrated circuit (ASIC). The ASIC can reside in a user terminal. Alternatively, the processor and the storage medium can reside as discrete components in a user terminal.

The phrase “non-transitory” as used in this document means “enduring or long-lived”. The phrase “non-transitory computer-readable media” includes any and all computer-readable media, with the sole exception of a transitory, propagating signal. This includes, by way of example and not limitation, non-transitory computer-readable media such as register memory, processor cache and random-access memory (RAM).

The phrase “audio signal” is a signal that is representative of a physical sound.

Retention of information such as computer-readable or computer-executable instructions, data structures, program modules, and so forth, can also be accomplished by using a variety of the communication media to encode one or more modulated data signals, electromagnetic waves (such as carrier waves), or other transport mechanisms or communications protocols, and includes any wired or wireless information delivery mechanism. In general, these communication media refer to a signal that has one or more of its characteristics set or changed in such a manner as to encode information or instructions in the signal. For example, communication media includes wired media such as a wired network or direct-wired connection carrying one or more modulated data signals, and wireless media such as acoustic, radio frequency (RF), infrared, laser, and other wireless media for transmitting, receiving, or both, one or more modulated data signals or electromagnetic waves. Combinations of the any of the above should also be included within the scope of communication media.

Further, one or any combination of software, programs, computer program products that embody some or all of the various embodiments of the system and method described herein, or portions thereof, may be stored, received, transmitted, or read from any desired combination of computer or machine-readable media or storage devices and communication media in the form of computer executable instructions or other data structures.

Embodiments of the system and method described herein may be further described in the general context of computer-executable instructions, such as program modules, being executed by a computing device. Generally, program modules include routines, programs, objects, components, data structures, and so forth, which perform particular tasks or implement particular abstract data types. The embodiments described herein may also be practiced in distributed computing environments where tasks are performed by one or more remote processing devices, or within a network of one or more devices, that are linked through one or more communications networks. In a distributed computing environment, program modules may be located in both local and remote computer storage media including media storage devices. Still further, the aforementioned instructions may be implemented, in part or in whole, as hardware logic circuits, which may or may not include a processor.

Conditional language used herein, such as, among others, “can,” “might,” “may,” “e.g.,” and the like, unless specifically stated otherwise, or otherwise understood within the context as used, is generally intended to convey that certain embodiments include, while other embodiments do not include, certain features, elements and/or states. Thus, such conditional language is not generally intended to imply that features, elements and/or states are in any way required for one or more embodiments or that one or more embodiments necessarily include logic for deciding, with or without author input or prompting, whether these features, elements and/or states are included or are to be performed in any particular embodiment. The terms “comprising,” “including,” “having,” and the like are synonymous and are used inclusively, in an open-ended fashion, and do not exclude additional elements, features, acts, operations, and so forth. Also, the term “or” is used in its inclusive sense (and not in its exclusive sense) so that when used, for example, to connect a list of elements, the term “or” means one, some, or all of the elements in the list.

While the above detailed description has shown, described, and pointed out features as applied to various embodiments, it will be understood that various omissions, substitutions, and changes in the form and details of the devices or algorithms illustrated can be made without departing from the scope of the disclosure. As will be recognized, certain embodiments of the inventions described herein can be embodied within a form that does not provide all of the features and benefits set forth herein, as some features can be used or practiced separately from others.

Unless otherwise stated, the foregoing alternative examples are not mutually exclusive, but may be implemented in various combinations to achieve unique advantages. As these and other variations and combinations of the features discussed above can be utilized without departing form the subject matter defined by the claims, the foregoing description should be taken by way of illustration rather than by way of limitation of the subject matter define by the claims. In addition, the provision of the examples described herein, as well as clauses phrased as “such as”, “including” and the like, should not be interpreted as limiting the subject matter of the claims to the specific examples; rather, the examples are intended to illustrate only one of many possible examples. Further, the same reference numbers in different drawings can identify the same or similar elements.

1. A method of inferring user behavior using a client application, the method comprising:
identifying, with one or more processors, application programming interface (API) traffic on a client application for a digital service, the API traffic generated by a user's interactions with the client application;
correlating, with the one or more processors, the API traffic with particular user behaviors; and
inferring, with the one or more processors, user behavior metrics based on the API traffic.

2. The method of claim 1, wherein the client application comprises a collection of endpoints, each of which deliver a specific subset of services of the digital service.

3. The method of claim 2, wherein the endpoints correlate with one or more of a plurality of features of the client application.

4. The method of claim 3 wherein the features comprise available selections, actions, inputs, and outputs delivered by the client application to the user.

5. The method of claim 1, further comprising adjusting offerings of the digital service based on the user behavior metrics.

6. The method of claim 5, wherein the digital service is a media broadcasting service, and wherein adjusting the offerings comprises changing specific media assets that are broadcast, changing a frequency of broadcasting particular media assets, or changing a timing of broadcasting particular media assets.

7. The method of claim 6, wherein the media assets are songs and the media broadcasting service is a radio broadcasting service.

8. The method of claim 1, wherein the user behavior metrics categorize user behaviors based on one or more parameters selected from the group consisting of: time, location, frequency, popularity, and number of clients using one of a plurality of features.

9. The method of claim 1, wherein inferring the user behavior metrics is performed in real time while the user is interacting with the client application.

10. The method of claim 9, further comprising using a “disp” parameter to determine if live requests were used for a “tuned” station, a “guide”, or a “preset” to permit more granular inference of behavior.

11. The method of claim 10, where the disp parameter is used to describe the status of a data set to a system and instruct the system what to do with the data set after termination of a step or job.

12. A system comprising:
memory; and
one or more processors in communication with the memory, the one or more processors configured to:
identify API traffic on a client application for a digital service, the API traffic generated by a user's interactions with the client application;
correlate the API traffic with particular user behaviors; and
infer user behavior metrics based on the API traffic.

13. The system of claim 12, wherein the client application comprises a collection of endpoints, each of which deliver a specific subset of services of the digital service.

14. The system of claim 12, wherein the one or more processors are further configured to adjust offerings of the digital service based on the user behavior metrics.

15. The system of claim 12, wherein the user behavior metrics categorize user behaviors based on one or more parameters selected from the group consisting of: time, location, frequency, popularity, and number of clients using one of a plurality of features.

16. The system of claim 12, wherein inferring the user behavior metrics is performed in real time while the user is interacting with the client application.

17. The system of claim 12, wherein the user behavior is inferred without any identifying information of the user.

18. A non-transitory computer-readable medium storing instructions executable by one or more processors for performing a method for inferring user behavior using a client application comprising:
identifying API traffic on a client application for a digital service, the API traffic generated by a user's interactions with the client application;
correlating the API traffic with particular user behaviors; and
inferring user behavior metrics on the API traffic.

19. The non-transitory computer readable storage medium of claim 18, wherein the user behavior metrics categorize user behaviors based on one or more parameters selected from the group consisting of: time, location, frequency, popularity, and number of clients using one of a plurality of features.
